(19) United States
(12) Patent Application Publication
(10) Pub. No.: US 2008/0195523 A1
(43) Pub. Date: Aug. 14, 2008

(54) TRANSFERRING PRODUCTS TO VARIOUS PLATFORMS

(76) Inventors: Nancy J. Rabenold, Brandon, FL (US); James A. Simmons, Brandon, FL (US)

Correspondence Address: SMITH FROHWEIN TEMPEL GREENLEE BLAHA, LLC, Two Ravinia Drive, Suite 700, ATLANTA, GA, 30346, US

(21) Appl. No.: 11/680,941

(22) Filed: Mar. 1, 2007

Related U.S. Application Data
(63) Continuation-in-part of application No. 11/672,988, filed on Feb. 9, 2007.

(51) Int. Cl. G06Q 40/00

(52) U.S. Cl. 705/37

(57) ABSTRACT

Products can be listed on one electronic platform and then easily moved to another network based platform based on the occurrence of a triggering event. If a product owner lists a product on an electronic platform, there is an expectation of the product being sold. However, if a triggering event occurs, such as the product is listed for a specific time period without being sold, or the bidding activity is below a desired threshold or simply the owner decides it is time to try something new, the owner can select one or more destination platforms on which to list the product. For each platform, descriptive information about the product is obtained using a variety of techniques and then provided to the destination platform for the listing of the product. The descriptive information can be obtained from the information available in the acquiring platform, public records such as those available over the Internet, database records, interpretation of serial numbers or VIN numbers, user profile information, information directly entered by the winner of the auction or other parties, etc. The descriptive information is converted to a format that is compatible with the destination platform.

### CROSS-REFERENCE TO RELATED APPLICATIONS

This application is a continuation-in-part of U.S. patent application Ser. No. 11/672,988 entitled FLIPPING PRODUCTS BETWEEN PLATFORMS filed on Feb. 29, 2007 and incorporates by reference U.S. Pat. No. 6,813,612 issued on Nov. 2, 2004.

### BACKGROUND OF THE INVENTION

In a January 2005 article by Frank Fortunato entitled “Welcome to the Jungle: The Two Sides of eBay”, it was reported that “eBay claims that 430,000 people earn a living on the site” (meaning at ebay.com). And although eBay is the big-boy on the block when it comes to consumer based, on-line auctions, they are not the only players that are experiencing an incredible amount of success in the industry. Other well known participants in the industry include Yahoo and Amazon.com. But that is just the beginning, there are online auctions available from an incredibly large list of participants, only some of which include uBid.com, shopgoodwill.com, auctionfire.com, bid-alot.com, webidz.com, buyselltrades.com, onlineauction.com, Sams Club, and shopzilla.com. In fact, at the time of authoring this background, a GOOGLE search of “online auctions” returns over 52 million hits. The Internet and online auctions has changed the way we shop and have created viable jobs for many individuals and small businesses.

However, as in most businesses, profits can be increased by moving more products faster. Certainly many other business principles also apply to the online auction industry, such as “buy low and sell high” and “strike while the iron is hot”. As such, in the online auction industry and in the electronic commerce industry, it is desirable to be able to move products from one platform to the next to increase the number of “eyeballs” that view the product, and hence increase the probability for selling the product. For high-volume companies, listing products on various electronic platforms can be a tedious and time-consuming task, as well as expensive. As such, many companies that move a significant amount of product through online platforms find it necessary to hire staff for entering data into the online platforms and monitoring the activity. However, in many circumstances, product that has been listed on one electronic platform or that is listed in an electronic format such as an inventory or database, on an on-line store, or other sources may already have pertinent information available online and rather than re-keying that information into another electronic platform it is desirable for this information to be transferred from one source to another.

As was uttered by the Captain in the movie Cool Hand Luke “what we have here is a failure to communicate”. This is a hurdle that needs to be overcome to provide for the seamless transferring of product from one electronic platform to another. The communication not only requires a medium, but also a common language. One viable medium in this scenario is obviously the Internet and thus, the main problems associated with meeting this need in the art includes the existence of a common language and an opportunity to communicate. Thus, there is a need in the art for a solution that enables product owners to transition the products from one platform to another platform. Any automation that can be incorporated into this process can greatly impact the ability to move product faster, and as such, improve a company's profits.

Another auctioning market that has heavily delved into the online arena is the traditional type auctions that have utilized the Internet to enable remote bidders to participate in a live auction as though they were actually present. Auction Management Solutions is a leading provider of technology that enables this functionality. One of the products offered by Auction Management Solutions is their ONLINE RINGMAN product which enables an auctioneer to control a live auction and manage the pace of the auction, as well as interact with remote bidders in a manner that can make them feel as though they are a part of the auction. In many of the auctions that are run using the ONLINE RINGMAN system, as well as similar systems, the information about the lot or product being bid on is available online. As such, if the product does not move in the auction, the owner may want to move the product to a different platform. Thus, there is a need in the art for a solution that would enable such product owners to easily transfer their products from one platform, to a different platform or arena.

### BRIEF SUMMARY OF THE INVENTION

In general, the embodiments of the present invention enable a product owner to move or transfer his product from one platform to another platform in an effort to sell the product. More specifically, one embodiment of the present invention enables a product owner that has listed the product for sell on one electronic platform, to move the product to another electronic, network based market place. As an example, a party may wish to sell a product through an online auctioning system but, have a minimum amount that he or she is willing to sell the product. If the auction closes without the reserve price having been met, the owner of the product may want to quickly move to the product to another electronic platform. The product owner can select one or more destination platforms on which to list the product. For each platform, descriptive information about the product is obtained using a variety of techniques and then provided to the destination platform for the listing of the product. The descriptive information can be obtained from the information available in the active platform, public records such as though available over the Internet, database records, interpretation of serial numbers or VIN numbers, user profile information, information directly entered by the winner of the auction or other parties, etc. In some embodiments, the descriptive information is converted to a format that is compatible with the destination platform.

One embodiment of the present invention operates to facilitate transferring of product offerings from one platform to another. When a product is made available on an electronic platform, descriptive elements, or information about the product, are identified. The descriptive elements are then formatted in accordance with or compatible with a destination platform. The formatted descriptive elements are then transmitted to the destination platform and the product is listed on the destination platform. Furthermore, embodiments of the present invention may accept profile information that identifies products or classes of products that are qualified for being transferred. This information may identify products by categories, part-numbers, etc. and may also identify one or more platforms on which to resell the products. Furthermore, the present invention may transfer or move products between platforms based on triggering events. For instance, if an owner knows that certain platforms are going to be more suited at different times, a schedule may be established for moving the product from one platform to the next. As such, the expiration of time windows operates as the triggering event. Likewise, if an auction ends without meeting the reserve by a certain percentage, the product may be moved to an alternate platform, otherwise, the product may be re-listed on the same platform.

The descriptive elements or information may be obtained in a variety of manners. Non-limiting examples include scraping a displayed screen to obtain the descriptive elements, searching the Internet for further identifying information, soliciting information from the acquiring party, and accessing a database containing product descriptive information.

The invention may be implemented within the currently active platform, within the destination platform, within a device external to both the active platform and the destination platform, or in a combination of two or more of these. In either scenario, the descriptive information on the active platform must be formatted to be compatible with the destination platform. In one embodiment an intermediary may receive the descriptive information in one format and then convert it to another format before sending it to the destination. In another embodiment, the information may be converted at the active platform and then directly transferred to the destination platform. In yet another embodiment, the destination platform or an intermediary may access the active platform to obtain the descriptive information.

The information can be transferred in a variety of manners including FTP transfers, email transfers, SMTP transfers, proprietary protocols and data structures, or any of a variety of other techniques.

In another embodiment of the invention, a system may be used to facilitate moving products from one platform to another. The system may include an active platform interface, a destination platform interface and a transfer engine that communicates with the active platform and the destination platform through the respective interfaces. This embodiment of the present invention is operable detect the occurrence of a triggering event and determine if products need to be moved to an alternate platform based on the triggering event. Information about the product is obtained from the active platform or other sources, formatted to be compatible with the destination platform(s) and then provided to the destination platform through the destination platform interface.

### BRIEF DESCRIPTION OF THE SEVERAL VIEWS OF THE DRAWING

FIG. 1 is a block diagram of an exemplary integrated live auction environment and online auction environment suitable for various embodiments of the present invention.

FIG. 2 is a block diagram illustrating a high-level description of an environment suitable for embodiments of the present invention.

FIG. 3 is a screen shot of an item available for bid during a scheduled Ritchie Brothers Auction.

FIG. 4 is a screen shot of a form presented on the TRACTORHOUSE.COM website to a registered user that desires to list a product for sale.

FIG. 6 is a flow chart diagram illustrating the general steps or processes involved in an exemplary embodiment of the present invention.

FIG. 7 is a state diagram illustrating the migration of a product from one channel to the next.

### DETAILED DESCRIPTION OF THE INVENTION

Embodiments of the present invention, in general, are directed towards placing product onto a platform for acquisition and then, automatically or semi-automatically moving, transferring, and/or additionally listing the items onto a different platform. Advantageously, embodiments of the present invention enable products to be acquired and sold in an expeditious and/or procedurally efficient and easy manner, as well as provide flexibility for a product supplier in the ease and efficiency of listing the products on varying platforms. In an exemplary embodiment of the present invention, items are listed on a first platform and then, as the result of a triggering event and/or a time lapse automatically making the product available on another platform. More specifically, such an exemplary embodiment could allow items to be listed on an system such as Auction Management Solutions' ONLINE RINGMAN and then to automatically, or semi-automatically, move these items to another platform, such as eBay, and make them available for acquistion through an online market or other listing mechanism upon the occurrence of a triggering event. For instance, if a particular auction provided through the ONLINE RINGMAN did not result in the acquisition of a particular product, then this could be a triggering event that would result in moving the product to a different platform. The triggering events can be any of a variety of events including, but not limited to, time outs, low threshold of activity, approaching of a desired venue such as a particular auction, a random occurrence, etc. Thus, items can be listed on a first platform and then either moved, transferred added to another platform or even re-listed on the same platform.

For instance, another embodiment of the present invention provides a solution to the afore mentioned needs in the art, as well as other needs by enabling the listing of items onto a first platform or arena and then onto a second platform or arena in response to a triggering event, with the arenas either being online arenas or including an online interface. More specifically, one embodiment of the present invention enables a product owner to automatically move that product from one platform to a different or additional platform. Advantageously, this aspect of the present invention enables the owner of inventory to quickly move inventory from one arena, to a different arena. This is generally accomplished by identifying a destination platform, determining the information required to list the products on that platform, identifying the format for such required information, converting the information available on the platform from which the products are presently listed to the format for the destination platform, filling in or obtaining missing information and then engaging the destination platform for the sell of the products.

Now, turning to the figures, various aspects, features, embodiments and advantages of the present invention will be more fully described.

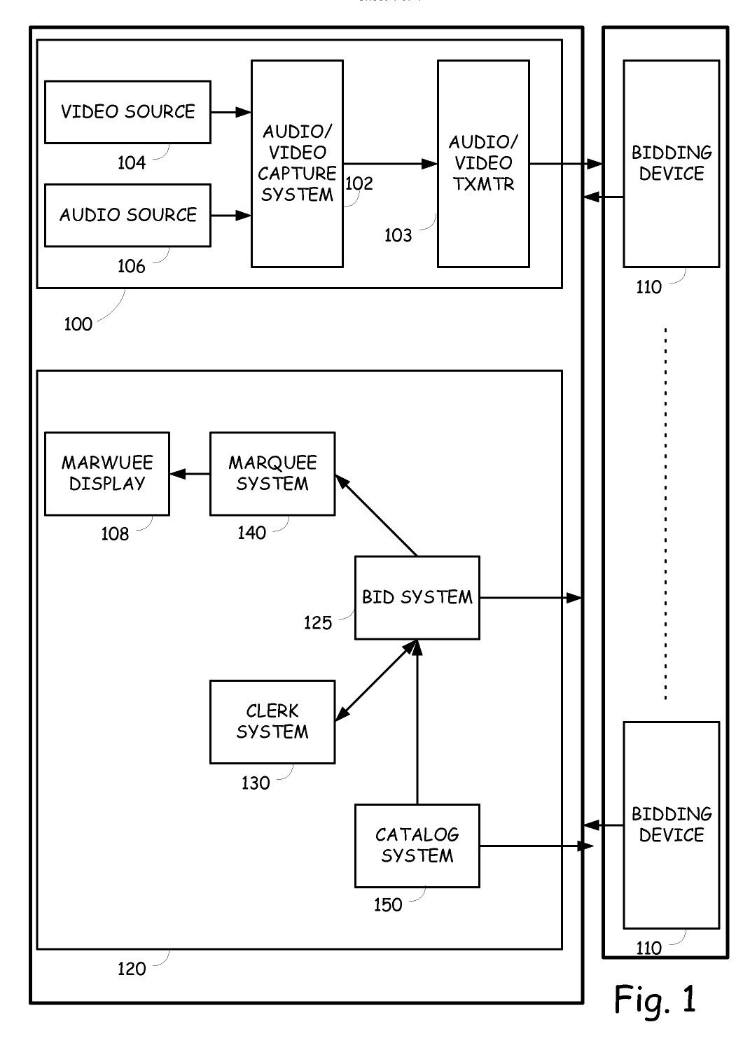

FIG. 1 is a block diagram of an exemplary integrated live auction environment and online auction environment suitable for various embodiments of the present invention. In the illustrated environment, the system includes:

An audio/video system 100 for delivering live audio and video feeds from the auction floor to the remote bidders;

One or more bidding devices 110 used by the remotely participating bidders to, among other things, monitor various auctions, bid on various items and render the audio and video information to the bidder; and

A bid processing system 120 that operates to control the interaction among the remote bidders, a clerk and/or an auctioneer and the local bidders attending the auction.

In an exemplary embodiment, the audio/video system 100 includes a video source 104, an audio source 106, and an audio/video capture system 102, all of which are typically located at the auction site and an audio/video transmitter 103 for providing the audio and video signals to the one or more bidding devices 110. The audio/video system 100 operates to receive an audio and/or video stream from the audio/video capture system 102, provide the encapsulated data to the audio/video transmitter 103 and then to deliver this data to one or more bidder devices 110. The audio/video capture system 102 can be implemented in a variety of manners, one of which may consist of suitable hardware cards installed in a computer system. The audio/video capture system 102 encapsulates the audio/video stream from the auction floor by interfacing to the audio source 106 and/or the video source 104. The audio/video system 100 operates to gather this audio and/or video data and transmit or broadcast the data in an appropriate format to one or more of the bidder devices 110. Further details of one embodiment of the audio/video system 100 can be found in U.S. Pat. No. 6,813,612; however, it will be appreciated that many other embodiments can be utilized in various implementations of the present invention and in addition, aspects and features of the present invention may be incorporated into a system that does not provide audio, video or both.

The bid processing system 120 may take on a variety of embodiments, such as those disclosed in U.S. Pat. No. 6,813,612, and/or encapsulated in the ONLINE RINGMAN system developed and marketed by Auction Management Solutions of Tampa Fla., as well as other similar systems. For illustrative purposes, a non-limiting example of a suitable bid processing system 120 may include a bid system 125 and a clerk system 130. Data for an item to be sold in the auction can be extracted from a catalog system 150 that maintains the pre-sales information prior to the auction start, and transferred to the bid system 125, and broadcast to various bidder devices 110 bidding participants, bid acceptance, etc. may be transmitted to the marquee system 140 and/or the bidder devices 110, and logs can be maintained identifying activity including the status of each bid made by a remote bidder or local bidder. The bid system 125 may include a “bid engine” algorithm to facilitate controlling the bidding process. The bid engine can be implemented to support one or more of the bidding models that function to control the bidding process. The various bidding models can be used to define the level of automation in the bidding process (i.e., whether the auctioneer is in total control of all aspects of the bidding process or if some of the functions are performed automatically outside of the auctioneers control), the bid increments, the ability to enter starting bids, display formats, etc. U.S. Pat. No. 6,813,612 defines four specific bidding models identified as the CHEROKEE, IROQUOIS, MOHAWK and APACHE models; however, other bidding models may also be utilized in conjunction with the various aspects and features of the present invention.

A detailed embodiment of an exemplary bidding device 110 is more fully described in U.S. Pat. No. 6,813,612, however, it should be appreciated that various aspects and features of the present invention can be realized in other embodiments of a bidding device. Basically, for various embodiments of the present invention, the bidding device simply needs to include a display or other user presentation interface, a user input interface, a bid processing system interface, a processing unit for executing a software or firmware process implementing the various steps involved in embodiments of present invention and optionally an audio output interface.

Aspects of the present invention can be implemented using a variety of hardware platforms, software languages and programming environments. Those skilled in the art will readily observe that implementing the present invention in various environments will naturally require the use of various technologies. However, the present invention is not limited to any particular division of hardware/software functionality, hardware components, software languages, or programming techniques. Thus, references within this description identifying design particulars, although in and of themselves may be considered novel and inventive, are provided primarily for illustrative purposes and should not be construed to limit the present invention but rather are additive.

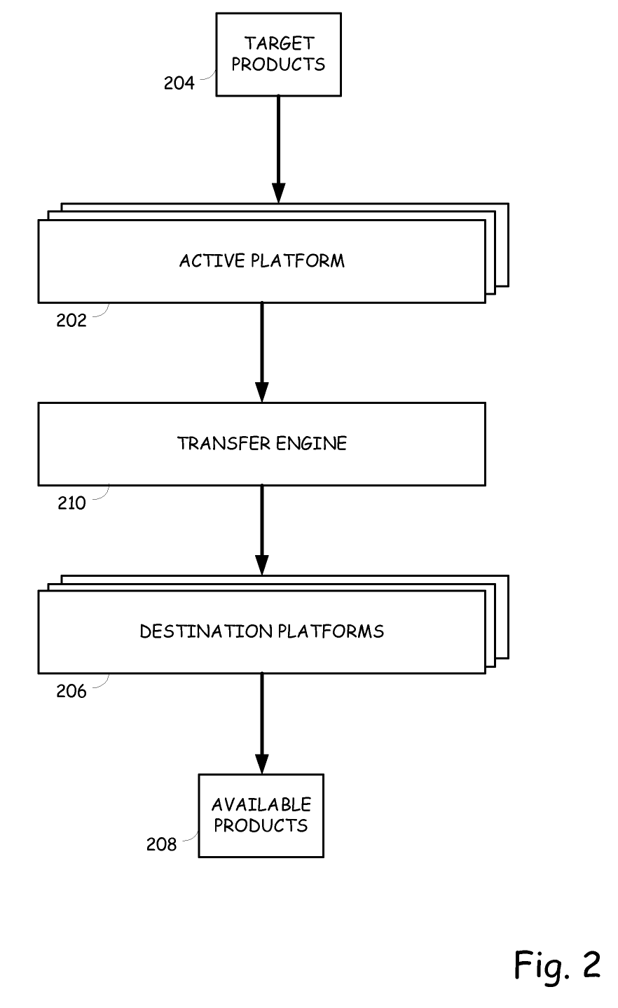

FIG. 2 is a block diagram illustrating a high-level description of an environment suitable for embodiments of the present invention. Active platforms 202 are shown as providing availability or access to one or more target products 204. It will be appreciated that embodiments of the present invention may work with a single active platform, multiple homogenous platforms or multiple heterogeneous platforms. Thus, the target products 204 may be similar or consistent across the embodiments, may be limited to a small subset of product types, or may range over an incredibly large number of classes and types. For instance, in an exemplary embodiment of the present invention the active platforms 202 may include an online auctioning platform, an online retail store, a physical store that posts purchases to the Internet or sends confirmations via email, an online interface to a physical store, an online or electronically accessible catalog or inventory database, etc. In another embodiment, the acquiring platforms 202 may be multiple online systems that provide access to an auction house. For instance, ONLINE RINGMAN may host auctions in various auction houses and each auction house may represent a different active platform 202. In the former example, a wide variety of target products 204 may be active whereas in the latter example, the target products 204 may be limited to automobiles or vehicles.

One or more destination platforms 206 may then be used to re-list or sell the target product(s) 204 acquired from the acquiring platform 202. Similarly, the destination platforms 206 may be a single platform, multiple homogenous platforms or multiple heterogeneous platforms. Regardless of the configuration, one or more of the target products 204 actively listed on the one or more acquiring platforms 202 can be moved, transferred or added as available products 208 on the one or more destination platforms 206.

The transfer engine 210 is the element that enables target products 204 that are currently or previously listed on the one or more active platforms 202 to be listed or made available on the one or more destination platforms 206 as available products 208. The transfer engine 210 may take on a variety of embodiments including a stand alone system that is accessible via the Internet, software that is embedded in either the one or more acquiring systems or destination systems, or even distributed among both, as well as other embodiments. In general, the transfer engine 210 operates to identify or receive notification of target products 204 that are to be made available on a destination platform 206, obtain or solicit the information required to list the target product 204, and then make the target product 204 an available product 208 on one or more destination platforms 206. It will be appreciated that information available from an active platform 202 may be different, deficient, superfluous, incompatible or otherwise inadequate to satisfy the requirements for listing the product on a destination platform 206. Yet, in other situations, the information available from an active platform 202 pertaining to a target product 204 may be directly ported over to a destination platform 206 for an available product 208. Thus, the transfer engine 210 may take on a variety of capabilities depending upon various embodiments and various requirements imposed upon the embodiments. For example, in one embodiment, the transfer engine 210 may simply extract information from a form describing a target product and port that information into appropriate fields of a form describing the available product 208. However, in an alternate embodiment, the transfer engine 210 may be required to perform one or more of the following actions, or even other actions that may become necessary: (a) extract information from a database, such as the catalog system 150 housing information about the seller of the available product 208; (b) solicit information from the seller through various means including emails, automated telephone calls, pages, mailing of postcards, requests made upon logging onto the system, etc.; (c) conduct an electronic search on the Internet for further information; (d) contact a product dealer for further information; and (e) contact the active platform 202 for further details.

As a particular example of an embodiment of the present invention, consider the a tractor currently listed for auction in a Ritchie Brothers Auction provisioned by Auction Management Systems' ONLINE RINGMAN. The owner also desires to list the product on the online market of TRACTORHOUSE.COM located at www.tractorhouse.com. In general, the various embodiments of the invention operate to extract information from the active platform 202 and then interject this information, either by itself or augmented with additional information, into the destination platform 206. The techniques employed for providing this general functionality can be quite varied.

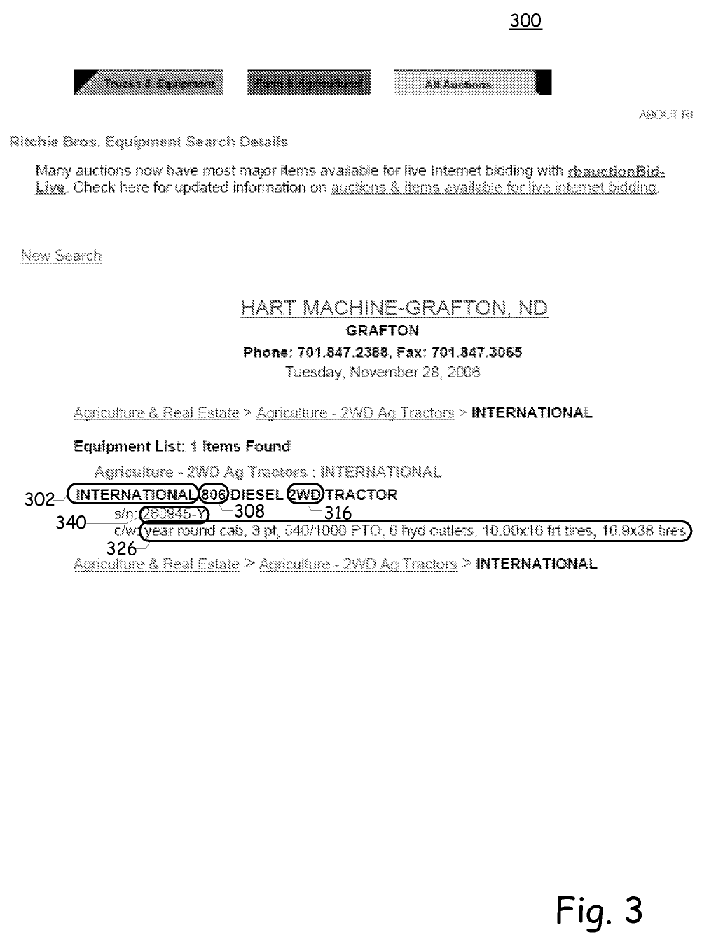

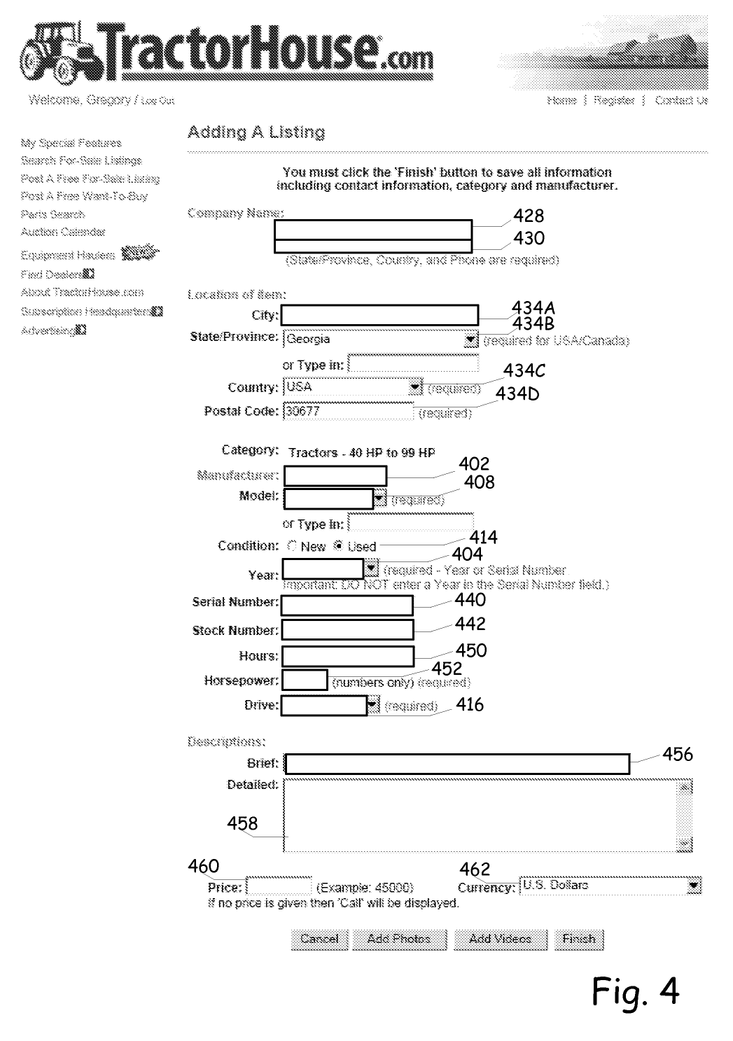

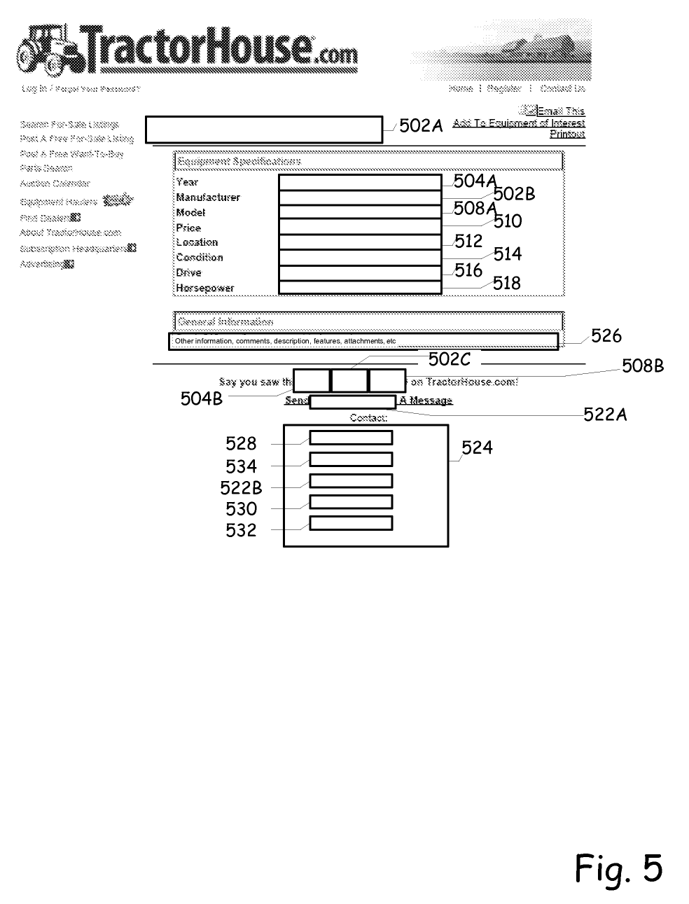

In one embodiment of the present invention, an external system can be used to fully implement functionality of the present invention in a non-intrusive manner. Thus, this embodiment of the present invention can operate without having to modify the existing active and destination platforms. In this embodiment of the invention, the transfer engine 210 exists entirely external to the active platform and the destination platform. This embodiment of the present invention is best illustrated by reference to FIGS. 3-5. FIG. 3 is a screen shot of an item available for bid during a scheduled Ritchie Brothers Auction. The screen shot 300 provides information regarding a target product 204 available on the Ritchie Brothers online auction platform that could represent a target product 204 to be flipped onto a destination platform 206. FIG. 4 is a screen shot of a form presented on the TRACTORHOUSE.COM website to a registered user that desires to list a product for sale. The screen shot 400 includes multiple fields to be completed for listing the product. Some of the fields are automatically populated by information about the user that is maintained by the website. Other fields may need to be entered as a product is registered or listed on the site. In general, this embodiment of the present invention gathers information extrinsically available without having to modify or intrude the active platform and then, inserts this information into the destination platform in a standard fashion. Using an embodiment of this invention, when a product is acquired, such as the tractor shown in screen shot 300 of FIG. 3, the external system accesses the information available and displayed on the screen. The screen shot 300 of FIG. 3 includes the following information about the target product 204:

the manufacturer of the tractor—International 302;

the model number of the tractor—806 308;

the drive train of the tractor—2 wheel drive (2WD) 316;

general descriptive information—year round cab, 3 pt, 540/1000 PTO, 6 hyd. outlets, 10.00×16 frt tires, 16.9×38 tires 326; and

the serial number of the tractor—260945-Y 34.

If a trigger event occurs, the external system then operates to list the target product 204 on the one or more destination platforms 206. The product owner can interface to the external system prior to notify the external system as to what destination platforms 206 are desired for the product. Alternatively, the external system can be set up to receive signals or indicators of the occurrence of a triggering event and then prompt the product owner or solicit from the owner instructions regarding the destination platforms. Those skilled in the art will appreciate that many techniques, above and beyond what is described herein, can be used to (a) identify products that are to be listed on an different or additional platform and (b) identify the destination platforms for those products.

This embodiment of the present invention can obtain the target product 204 information by searching the content of the screen shot 300 for keywords and then scraping the screen to obtain the values associated with the keywords. For instance, the key word “s/n” can be searched for to find the serial number for the purchased tractor. In addition, the screen can be scraped and then parsed/analyzed to identify other product characteristics. If the external system identifies the word “International” on the screen 300, the external system can identify this as a tractor manufacturer from a list of known manufacturers. However, because a word such as “International” can potentially appear on the screen for other purposes than to identify a tractor manufacturer, the external system must also apply a level of intelligence to verify the use of the word. In the present example, the context of the word indicates that it is being used to identify the manufacturer of the tractor. Similarly, the other occurrences of the word “International” can also be used to apply intelligence in identifying the manufacturer of the product.

This embodiment of the present invention also operates to automate the process of entering this product onto the destination platform. The screen shot 400 in FIG. 4 is the user interface displayed over the Internet for a registered user wanting to enter a product on the TRACTORHOUSE.COM website. The form displayed in screen shot 400 includes multiple fields to be completed. The external system can operate to access the TRACTORHOUSE.COM website, login the registered user, and then automatically populate the form and submit it to the TRACTORHOUSE.COM website. Those skilled in the art will understand that the external system can perform this task in a variety of manners including, as a programmed “bot”, by editing the form fields on an HTML level and submitting the form, or using other techniques or a combination of one or more techniques. The information to be provided in screen shot 400 includes the following fields:

company name 428;

company address 430;

location of product city 434A;

location of product state 434B;

location of product country 434C;

location of product zip code 434D;

manufacturer 402;

model 408;

condition 414;

year 404;

serial number 440;

stock number 442;

hours 450;

horse power 452;

drive 416;

brief description 456;

detailed description 458;

price 460; and

currency 462.

A quick examination of the fields to be completed in the screen shot 400 shows that there is not a one-to-one correspondence with the information available from screen shot 300. In fact, the only direct correspondence is the following fields illustrated in Table 1.

TABLE 1

| Screen shot 400 | Screen shot 300 |
|---|---|
| manufacture 402 | manufacturer of the tractor 302 |
| model 408 | model number of the tractor 308 |
| drive 416 | drive train of the tractor 316 |
| serial number 440 | serial number 340 |
| brief description 456 | general descriptive information 326 |

However, the transfer engine can apply intelligence to further populate the fields of the form displayed in screen shot 400. For instance, the transfer engine can review the general description information 326 for keywords that may apply to the specific form fields of screen shot 400. In addition, the transfer engine may use the serial number to look up manufacturer information regarding the product. Thus, by accessing the manufacturer's information based on the serial number of the product, the transfer engine may be able to populate the following fields: manufacturer 402; model 408; year 404; horse power 452; drive 416; brief description 456; and detailed description 458.

Other information for the form may automatically be completed by the TRACTORHOUSE.COM platform or can be provided to the transfer engine as user profile information. For example, when a user registers with TRACTORHOUSE.COM, certain information is required. This information includes address and contact information for the listing party as well as other similar information. Thus, this information can be automatically filled in by the TRACTORHOUSE.COM platform. The flipping engine can examine the fields of the form displayed on screen shot 400 to determine if the field has already be completed by the platform. If so, the flipping engine will not alter the form field. Information that can be automatically completed by the TRACTORHOUSE.COM platform may include the following fields: company name 428; company address 430; location of product city 434A; location of product state 434B; location of product country 434C; location of product zip code 434D; and currency 462. Some or all of this information can also be provided by the user as user profile information in the transfer engine. In some embodiments, the user profile information can take precedence over the automatically completed information and thus, the user can override the automatically filled in fields. Thus, if a user has a product actively listed in one location, the location information may be entered in the user profile and then populated into the screen shot 400 form rather than using the user's default address.

In some embodiments, such as one that could be utilized for the present example, the information required to list the product may simply not be available at the time the product is ready to be listed on the destination platform 206. In such a situation, the transfer engine can either solicit the information from the user and/or simply put placeholders into the form. As an example, the transfer engine may be configured to contact the user through various techniques such as an email message, a page, an automated phone call or even a manned phone call, and request the user to provide particular information. As another example, the transfer engine may simply populate the field with placeholder information, such as “TBD”, “Call Seller”, “unknown” or simply leave the form blank until the user accesses the system and completes the form. In the illustrated example, fields that may require interaction with the user include: location of product city 434A; location of product state 434B; location of product country 434C; location of product zip code 434D; condition 414; hours 450; brief description 456; detailed description 458; and price 460.

FIG. 5 is a screen shot 500 of a product listed on TRACTORHOUSE.COM that could be the result of tranferring a product as described above, or as described below in conjunction with an alternate embodiment of the invention. In the screen shot, various fields of information are presented to parties accessing the website and conducting a search that lands on the particular product.

FIG. 5 includes a main field to categorize the products by manufacturer 502A. The screen shot 500 then includes a window to provide equipment specifications which includes the year that the product was manufactured 504A, the manufacturer 503B, the model 518A, the price 510, the location of the product 512, the condition of the product 514, the type of drive of the product 516 and the horse power 518.

In addition the screen shot 500 includes a window containing contact information for the seller 524. The contact information includes a company name 528, and address 534, a contact name 522B, a telephone number 530 and a fax number 532. The screen shot 500 also includes a general information block that contains general information about the product 526. Finally, the screen shot 500 also includes an area to automatically send an email to the seller by clicking on a hyper link that is populated with the year 504B, manufacturer 502C and model 508B of the product and the contact name of the seller 522A.

In a highly integrated embodiment of the present invention, the extraction and interjection processes can be fully automated and integrated into the active platform and/or destination platform, or be facilitated by an external system. In this embodiment, the transfer engine can be distributed at various levels between the active platform 202, the destination platform 206 and/or a stand-alone system. It should be appreciated that this embodiment of the invention can exist wholly in one of these listed components or distributed at various levels among two or more of the components. In a general embodiment, the transfer engine is predominantly located in an external component but, has some elements existing within the acquiring platform 202 and the destination platform 206.

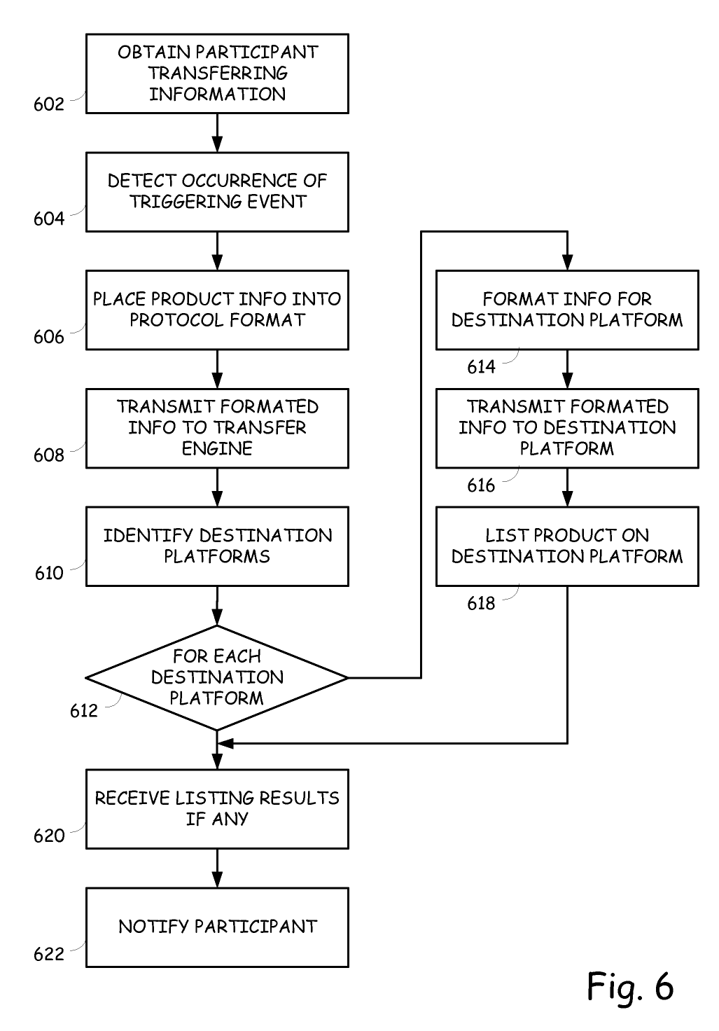

FIG. 6 is a flow chart diagram illustrating the general steps or processes involved in an exemplary embodiment of the present invention. It will be appreciated that the steps illustrated are for purposes of clarity and that the steps do not necessarily have to be conducted in the illustrated order, or in accordance with the described lines of demarcation. In fact, additional steps could be broken out of the illustrated steps or some of the steps may be combined. Further, portions of a step may occur at one point in time and other portions after one or more other steps have been initiated or completed. Yet, it should also be appreciated that the actual embodiment presented may in and of itself be considered novel but, the present invention is not necessarily limited to the illustrated embodiment.

In this highly-integrated embodiment, the active platform 202 includes operational components necessary to provide as output, the relevant information regarding a product, and the destination platform 206 includes operational components necessary to receive input information about an available product and then list that product. More specifically, transfer information is obtained from a participant 602. This information may be solicited by a stand-alone component of the transfer engine or may be solicited by the acquiring and/or destination platforms. Regardless, some component of the system needs to obtain knowledge regarding the transfer requirements or desires of the participant.

In one embodiment, this information is provided to the active platform. In this embodiment, as a user registers with the active system, such as an internet based auctioning system, the participant identifies his or her wishes regarding the transfer of the product. This information may simply state that particular products are to be transferred based on the occurrence of a specific triggering event and provide a destination for the communication of product information or the information may identify specific actions to take for specific products or classes of products.

If a triggering event occurs 604, the active platform detects such occurrence. If any products are identified as to be transferred based on the participant transfer information, then information about the product is formatted in accordance with a particular protocol 606. As previously described, the product description or descriptive elements can be obtained using a variety of techniques. Thus far screen scraping, internet based searching and user inquiry techniques have been described. Other techniques may also be employed such as maintaining a database of the product descriptions and accessing that database to obtain the necessary information. Similarly, a database of user profiles may also be maintained and accessible to the various components of the various embodiments of the invention.

The formatted information 606 can then be transmitted to the external component of the flipping engine 608. It will be appreciated that alternatively, the active platform may simply send a notice regarding the occurrence of a triggering event and the availability of product to the external component of the transfer engine and the external component can then acquire the information from the active system via a defined protocol. In one embodiment, the active system may send an email to the stand-alone component of the transfer engine indicating that a triggering event has occurred and that product is available for transfer. The email may include all of the specifics regarding the product or, as mentioned above may simply indicated that the product is available. Other techniques may also be used to communicate this information and although specific techniques may be considered novel, they are provided as non-limiting examples.

The information regarding the destination platforms can be provided in a variety of manners. In one embodiment, the user may identify the destination platform(s) by interfacing to the active platform. This can be done on a product by product basis or for all products or classes of products. Alternatively, the active platform may simply be instructed to send all or some of the active product information to the stand-alone component of the transfer engine and the stand-alone component may house the information regarding the particular destination platforms. It will be appreciated that the selection of destinations may be conducted based on a variety of circumstances. For instance, one category of products may be routed to one destination platform while another category of products are routed to a different destination. The destination determination may also be based on time and date information. For instance, if the product is seasonal, more destinations may be selected during a seasonally active time.

For each destination platform selected for a product 612, the information available for the product is formatted in a manner that is required or accepted by the destination 614. The formatted information is then transmitted to the destination platform 616. The destination platform then presents or lists the product on the destination platform 618.

Subsequently, if the listed item is bid on or purchased by someone using the destination platform 620, the user may be notified of such activity 622.

Thus, various embodiments, features and aspects of the present invention have been presented. In the most general sense, the various embodiments of the present invention allow a user to list products on one system and then to re-list those products for sale or auction on another system. The embodiments of the present invention can be rolled into a totally on-line system or can even be deployed in the traditional, non-networked based scenario. For instance, aspects of the present invention can be incorporated into an inventory control system in such a manner that as variously defined triggering events occur, the products in inventory are automatically made available or various platforms. Those skilled in the art will appreciate that embodiments of the present invention can also be incorporated into hybrid environments.

An exemplary embodiment of the present invention is to deploy the use of the invention to move product between two auctioning platforms. For instance, automotive auctions that include online components can be used to transfer product to another platform such as ebaymotors.com. Advantageously, embodiments of the present invention can create a seamless or nearly seamless operation for making products rapidly available on one or more platforms. The active platforms and destination platforms can include any of a variety of platforms. A few non-limiting examples of active platforms include online auctions, live in-person auctions, online stores, telephone orders, fax orders, orders placed through the use of interactive television, orders placed through cellular telephone orders, purchases made through a brick and mortar store, classified adds in newspapers of magazines, kiosk sales, and purchases made from advertisements. Similarly, any of these platforms may also be qualified as destination platforms. It should also be appreciated that the present invention may also be used to transfer a product right back onto the same platform. For instance, an owner may list a product on a platform and if it does not sell, immediately or after a delay, re-list the product on that platform. More specifically, an owner may list a product on ebay and after the auction expires, if the product did not sale and/or augmented by other criteria (i.e., the highest bid was within a certain percentage of the reserve or a minimum number of bids were received, etc), immediately list the product again.

Another embodiment of the invention can be viewed as moving product between various channels, where each channel is an electronic platform that can be used for offering the product for sale, rent, or other uses. The channels can be mutually exclusive to each other in that the product can only exist in one channel at a time, or the channels may be simultaneous meaning that the product can appear in more than one channel at the same time.

For each product, or group of products, a series of channels can be defined along with a series of events that will result in the products moving from one channel to the next. For each channel, various parameters and configurations of the product may be presented. For instance, the price may vary between channels, the accessories or available features may be modified, etc.

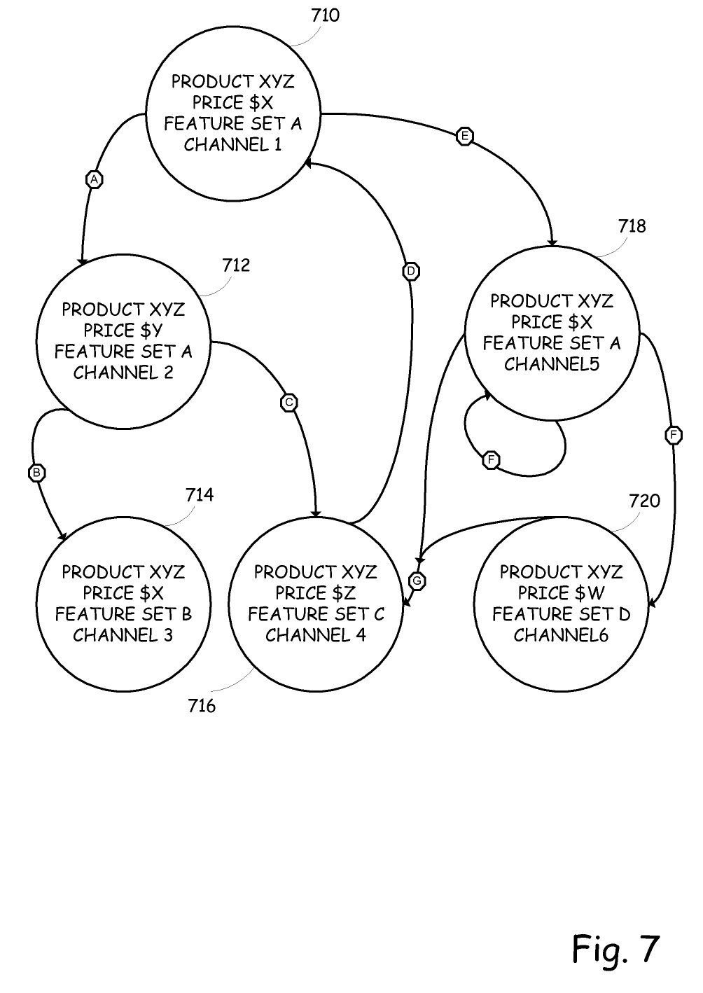

FIG. 7 is a state diagram illustrating one potential embodiment of the present invention. It will be appreciated that the specific examples provided in this description are for illustrative purposes and should not be construed as to limit the present invention. However, it will also be appreciated that the specific examples or portions thereof may also be considered novel in and of themselves. The state diagram represents the transitioning for a product XYZ as the result of various events. Initially, the product XYZ exists in state 710 which includes being available via Channel 1 at the price of $X and including feature set A. If event A occurs, the product XYZ then transitions to state 712 which includes channel 2 at price $Y with the same feature set. As a particular example, product $XYZ may be a Toyota 4-Runner available for purchase on the ONLINE RINGMAN system, fully loaded with a towing package as feature set A and having a minimum price or reserve price of $18,000. Event A could be the ending of the auction which would result in the product transition to eBay motors (channel 2) with the same feature set A but a reduced reserve price of $17,000.

If event B or C occurs while state 712 is active, the product becomes available in accordance with state 714 and 716 respectively. In state 714, the product XYZ is available at a price of $X, with feature set B and on channel 3. In state 716, the product XYZ is available at a price of $Z with feature set C on channel 4. If event D occurs while state 716 is active, then the product is again available in accordance with state 710 (assuming that state 710 closed down at the occurrence of event A). If event E occurs while state 710 is active, then the product XYZ becomes available in accordance with state 718 where the price is $X with feature set A and is on channel 5. If event F occurs while state 718 is active, state 718 remains active and state 720 is also initiated or spawned. In state 720 the product XYZ is available at the price of $W with feature set D on channel 6. If event F occurs, states 718 and 720 are closed down and state 716 is re-entered.

It should be appreciated that the events could be time outs, specific times of the day, the occurrence of any type of event or even simply as the result of a decision by the product owner or another entity that has the authority to transition the product to a different cannel. The various parameters of the product on the various channels can be defined by the owner up front and the product could enter a sequenced loop from state to state until the product is either sold or removed from the channels. Advantageously, in this embodiment of the invention the product owner can establish the channels for the product and then sit back and wait without having to be involved in the transition from one channel to the next.

Although the various embodiments of the present invention may be described with reference to particular embodiments having various features, those skilled in the art will appreciate that the embodiments are simply non-limiting examples. Thus, the various embodiments may incorporate all or only a portion of the above-described features and aspects.

What is claimed is:

1. A method for selling products, the method comprising the steps of:
identifying descriptive elements of a product available on a first platform;
formatting the descriptive elements in accordance with a destination platform;
transmitting the formatted descriptive elements to the destination platform; and
listing the product as an available product on the destination platform.

2. The method of claim 1, further comprising the steps of:
receiving transfer profile information identifying qualified products for being transferred; and
detecting the occurrence of a triggering event.

3. The method of claim 1, wherein the first platform is an electronic inventory and the step of identifying descriptive elements of the product further comprises extracting fields from the inventory for the entry corresponding with the product.

4. The method of claim 1, wherein the first platform is an online platform listing the product as available for acquisition and the step of identifying descriptive elements of the product further comprises scraping a displayed screen to obtain the descriptive elements.

5. The method of claim 4, wherein the step of identifying descriptive elements further comprises searching the Internet for further identifying information.

6. The method of claim 4, wherein the step of identifying descriptive elements further comprises soliciting information from the product owner.

7. The method of claim 1, wherein the step of identifying descriptive elements of the product further comprises accessing a database containing product descriptive information.

8. The method of claim 1, wherein the step of formatting the descriptive elements in accordance with a destination platform further comprises the steps of:
formatting the information into a first format;
transmitting the first formatted information to an intermediary node; and
formatting the information into a second format, the second format being compatible with the destination platform.

9. The method of claim 8, wherein the step of transmitting the first formatted information to the intermediary node further comprises emailing the information to the intermediary node.

10. The method of claim 8, wherein the step of transmitting the first formatted information to the intermediary node further comprises the steps of:
sending an indication to the intermediary node that information pertaining to the product is available;
receiving a request from the intermediary node for accessing the information; and
providing the information to the intermediary node in response to the received request.

11. The method of claim 1, wherein the step of transmitting the formatted descriptive elements to the destination platform further comprises sending an email message to the destination platform.

12. The method of claim 1, wherein the step of transmitting the formatted descriptive elements to the destination platform further comprises sending a message in accordance with a protocol compatible with the destination platform.

13. The method of claim 1, wherein the step of transmitting the formatted descriptive elements to the destination platform further comprises:
in response to the detection of a triggering event, sending an indication to the destination platform that information pertaining to the product is available;
receiving a request from the destination platform for accessing the information; and
providing the information to the destination platform in response to the received request.

14. A system for facilitating the transfer of the listing of products between platforms, the system comprising:
an active platform interface;
a destination platform interface; and
a transfer engine operative to communicate with the active platform through the active platform interface and the destination platform through the destination platform interface, the transfer engine being operative to:
detect the occurrence of a triggering event;
identifying one or more products associated with the triggering event;
obtain information about the one or more products from the active platform interface;
format the information to be compatible with the destination platform; and
provide the formatted information to the destination platform interface.

15. The system of claim 14, wherein the transfer engine is further operative to obtain information about the one or more products by searching for manufacturer's information about the product through the Internet.

16. The system of claim 14, wherein the transfer engine is further operative to obtain information about the one or more products by soliciting input from a user.

17. The system of claim 14, wherein the transfer engine is further operative to set default values for unknown information about the one or more products.

18. The system of claim 14, wherein the transfer engine is further operative to obtain information about the one or more products through a user profile.

19. The system of claim 14, wherein the transfer engine is further operative to obtain information about the one or more products from a database.

20. An apparatus for facilitating moving products from sell on a first platform to one or more second platforms, the apparatus comprising:
a first platform interface;
a destination platform interface; and
being operable to communicate with the first platform through the first platform interface and the destination platform through the destination platform interface to:
detect the occurrence of a triggering event associated with a particular product;
obtain information about the particular product from the first platform interface;
augment the information by searching for manufacturer's information on the Internet and accessing user supplied information;
format the information to be compatible with the destination platform; and
provide the formatted information to the destination platform interface.
